(19) United States
(12) Patent Application Publication
(10) Pub. No.: US 2003/0198313 A1
(43) Pub. Date: Oct. 23, 2003

(54) Thermal shunts and method for dry storage of spent nuclear fuel

(76) Inventor: John Kevin McCoy, Lynchburg, VA (US)

Correspondence Address: KENYON & KENYON, ONE BROADWAY, NEW YORK, NY, 10004, US

(21) Appl. No.: 10/125,901

(22) Filed: Apr. 19, 2002

(51) Int. Cl. G21C 19/00

(52) U.S. Cl. 376/272

(57) ABSTRACT

The invention comprises a structure for removing heat from a spent nuclear fuel assembly having a plurality of fuel rods. The invention comprises a fin configured from a thermally conductive material, a connector connected to the fin, the connector configured to be connected to the nuclear fuel assembly and at least one blade connected to the fin, the at least one blade configured from a thermally conductive material to be inserted in a space between the plurality of fuel rods.

### FIELD OF THE INVENTION

The present invention relates to dry cask storage for spent nuclear fuel assemblies. More specifically, the present invention relates to a thermal shunt which may be placed in a nuclear fuel assembly when stored in a dry storage cask to promote conduction of heat away from the spent fuel assembly.

### BACKGROUND INFORMATION

The storage of spent nuclear fuel assemblies has presented a challenging problem to the nuclear industry for many years. In the nuclear fuel cycle, fissionable nuclear fuel assemblies, comprised of a plurality of fuel rods, are placed in a nuclear reactor. The “new” fuel assemblies are positioned in specific locations in the reactor core along with other fuel left in the reactor from a previous operational run. The reactor is then operated with both the “new” fuel and “old” fuel for a period of time, usually 12 to 18 months. The fuel assemblies provide electrical generating capacity by heating a moderator, usually water. After 12 to 24 months of reactor operation the “new” fuel that was previously added is repositioned in the core and the reactor again operated for approximately 12 to 24 months. This process is usually repeated a third time with the fuel progressively becoming more depleted and radioactive during each step. After the third reactor operational run, the fissionable fuel in the assembly has generally been expended with the remaining materials of the fuel assembly being highly radioactive. The radioactivity of the fuel rod is usually of such a magnitude that the fuel assembly, now termed a “spent” fuel assembly, must be continually cooled to prevent degradation.

Spent fuel assembly cooling can take many different forms and is a necessary step in ensuring safe storage, transportation, and disposal. Most frequently, spent fuel assemblies are taken from the reactor and placed in a fuel pool where water is circulated and cooled to prevent assembly overheating. Over time, the fuel pool is required to store large numbers of fuel assemblies as the reactor uses more fuel. Throughout the lifetime of the nuclear facility, the fuel pool must often store a multitude of assemblies such that either one of two conditions are finally reached 1) no physical space remains in the fuel pool for storing spent assemblies or 2) the heat load of the spent assemblies becomes a cooling concern for the water in the pool (i.e. the water in the fuel pool may boil). As a result, spent assemblies must then be stored in an alternative way to prevent the detrimental effects of fuel pool overcrowding.

One alternative to fuel pool overcrowding is dry cask storage. Generally, spent fuel assemblies which have a low decay heat rate may be stored in a dry state. The spent fuel assemblies, which may be composed of fuel rods, water rods, in-core instrumentation and other devices, are placed in a pressure tight canister (cask) filled with a cooling medium, generally a helium gas. The cooling medium allows the assembly to radiate heat while helping to remove the heat generated. Although superior to storage in a fuel pool in some aspects, dry cask storage has many drawbacks which seriously limit the use of the technology on a large scale.

A first significant drawback for dry storage is the limited cooling capacity of a dry storage cask. Spent fuel assemblies must often be cooled in a fuel pool for an extended period of time prior to storage in a dry cask. This fuel pool cooling permits the spent fuel assembly to expend a sufficient amount of heat. (i.e. cool down) prior to incorporation into the cask. Fuel assemblies with a higher initial content of fissionable material and long in-core residence time possess decay heat rates that require extensive fuel pool cooling prior to the assembly being able to be incorporated into dry storage. The limited cooling capacity available in a dry storage cask therefore is a design feature which severely limits large scale use of the technology for many types of fuel assemblies.

A second significant drawback for dry storage is high radiation associated with handling the assemblies during preparation for storage. Highly radioactive fuel assemblies must be shielded with a thick cask and/or outer shell (i.e. overpack), usually concrete, to protect workers from receiving radiation doses in excess of permissible values. The construction of thick pressure tight casks and/or concrete storage vessels to house and handle the spent fuel assemblies and protect workers can be extremely expensive and prone to design and manufacturing flaws.

A third significant drawback to dry storage is the attainment and retention of a criticality safety margin. Dry cask storage systems typically include features to prevent criticality, even in the event that the cask is misloaded and moderator enters the cask. These features may include physical devices such as neutron flux traps or plates or rods of neutron absorber material. They may also include procedural controls on what may be loaded. Since nuclear criticality is dependent on geometry, the criticality control features must be designed to remain effective even in the event of an impact. Maintaining a criticality safety margin puts design constraints on the cask system and can significantly increase its cost.

A fourth significant drawback for dry storage is the requirement to “mix” different fuel assemblies during loading of a dry storage cask. In order to not exceed the cooling capacity of a dry storage cask, fuel must often be “mixed” where fuel assemblies with a lower heat decay rate are combined in a dry cask together with fuel assemblies with a higher heat decay rate. The resulting mixture of low and high decay heat rate fuel assemblies, therefore provides an overall average heat decay rate which may be accepted by the dry storage cask. To maintain this average, high decay heat rate fuel must generally be placed in the exterior portions of the fuel cask due to greater cooling capacity in these areas. The placement of the high decay heat rate fuel in these areas increases radiation dose rates on the exterior of the cask, ultimately presenting a radiation risk to workers. If high decay heat rate fuel is located in the center of the holding basket in the dry cask storage unit, the heat is more concentrated and must pass through more layers of material (i.e. layers of other fuel rods) to be effectively cooled.

A fifth significant drawback of dry storage is the potential loss of cooling medium, usually helium gas, from the dry storage cask. The dry storage cask requires a cooling medium to allow proper heat transfer between the spent fuel assemblies and the cask shell. Although dry storage casks are designed to prevent the cooling medium from escaping, loss of the cooling medium may cause significant internal heat buildup in the cask posing a significant safety risk.

There is therefore a need to provide a solution to the above stated drawbacks to promote safe and cost efficient storage of spent nuclear fuel assemblies in a dry storage cask.

### SUMMARY

It is therefore an object of the present invention to provide a structure to improve the limited cooling capacity of a dry cask storage unit. The structure should be incorporated into existing dry cask storage unit designs.

It is also an object of the present invention to provide a structure to limit the strong radiation field produced at the surface of the dry cask storage unit.

It is a further object of the present invention to provide a structure which will provide for an increase in the critical safety margin of spent fuel stored in a dry cask storage unit.

It is a still further object of the present invention to provide a structure to allow the mixing of different decay heat rate fuel assemblies.

It is another object of the present invention to provide a structure which will provide additional safety margin to stored spent fuel assemblies in the event that a moderator enters the dry fuel cask.

These and other objects of the invention, which will become apparent from the following detailed description, are achieved as described.

The invention comprises a structure for removing heat from a spent nuclear fuel assembly. The invention comprises a fin made from a thermally conductive material, a connector connected to the fin, the connector configured to be connected to the spent fuel assembly, and at least one blade connected to the fin, the at least one blade made from a thermally conductive material to be inserted in a space between the plurality of fuel rods.

A second embodiment of the invention is also described. The second embodiment comprises a structure for removing heat from a spent fuel assembly. The second embodiment comprises a fin made from a thermally conductive material, a connector connected to the fin, the connector configured to be connected to the spent fuel assembly, at least one blade connected to the fin, the at least one blade made from a thermally conductive material, the blade configured to be inserted in a space between the plurality of fuel rods, and a connection connected to the fin, the connection configured to conduct heat from the fin.

A method for cooling a spent nuclear fuel assembly is also disclosed. The method comprises attaching a thermal shunt to the fuel assembly, receiving heat from the fuel assembly into the thermal shunt, conducting the heat through the shunt and dissipating the heat.

### BRIEF DESCRIPTION OF THE DRAWINGS

FIG. 1 is a top plan view of thermal shunts installed on a spent fuel assembly in accordance with the present invention. FIG. 2 is a side view of thermal shunts installed on a pressurized water reactor spent fuel assembly.

### DETAILED DESCRIPTION

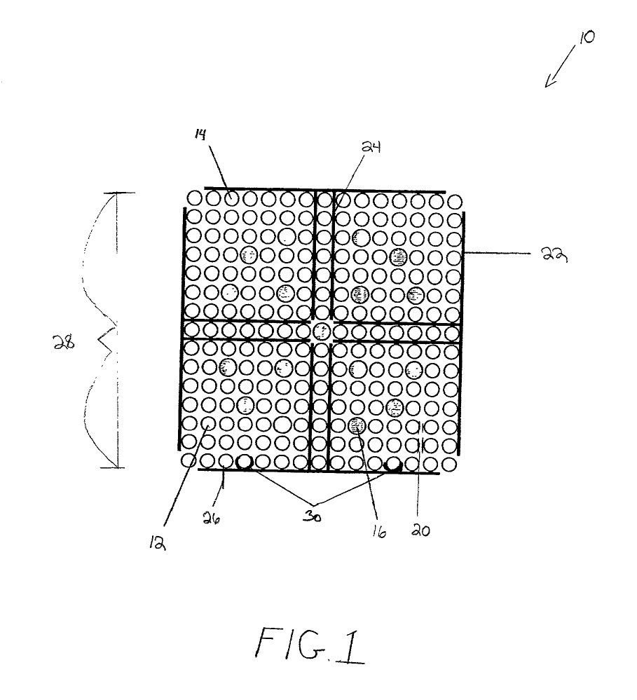

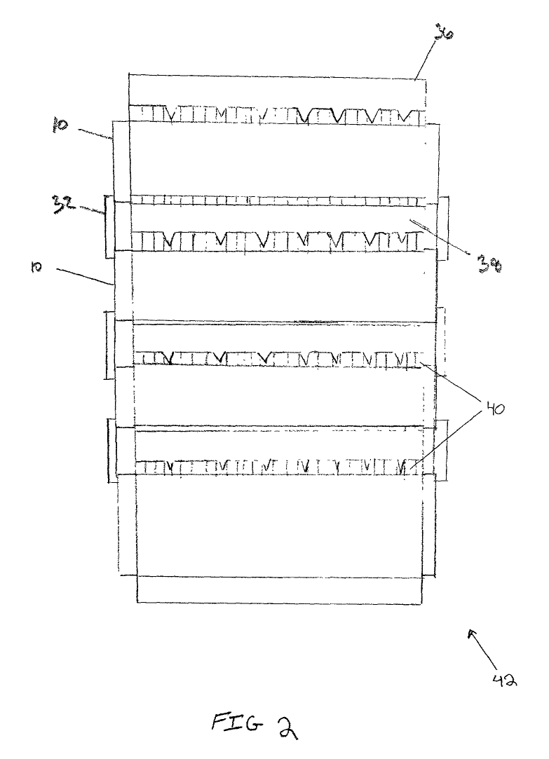

Referring to FIG. 1, a first embodiment of a thermal shunt 10 for the invention is shown. The thermal shunt 10 is comprised of a fin 22, at least one blade 24 attached to the fin 22 and a connection 26. Although shown as a specific type of pressurized water reactor (PWR) fuel assembly in FIG. 1, it will be understood by those skilled in the art that the thermal shunt 10 may be installed on other types of fuel assemblies so that the illustrated view of FIG. 1 is an illustrative example only.

The fin 22 of the shunt 10 may be configured to be placed on the exterior of the fuel assembly 12 while the fuel assembly 12 is positioned in a basket of a dry cask storage unit. As is typically in the design of a dry cask storage unit, multiple fuel assemblies are held in position by a basket (not shown), allowing for dense packing. The fin 22 may be constructed from thermally conductive material, such as for example aluminum, copper or silver, to allow heat conduction through the fin 22. The fin 22 may be constructed of a thickness of material sufficient to allow conduction of heat along the length of the fin 22 without the heat detrimentally affecting the structure of the fin 22.

A connection 26 is attached to the fin 22. The connection 26 allows, as an example, the shunt 10 to be connected to a fuel assembly 12. The connection 26 may be specifically designed to fit the exterior of a fuel rod 14 of the fuel assembly 12 to allow a positive contact between the shunt 10 and assembly 12. The connection 26 may also be designed to prevent the shunt 10 from moving during any jarring conditions such as those which may occur during movement of the fuel assembly 12 or during potential seismic events. The connection 26 may be manufactured from thermally conductive material to allow heat to be transferred from the connection 26 to the fin 22. The connection 26 may be connected to the fin 22 through a connection such as, for example, a screw and nut arrangement, a weld arrangement, a clip arrangement or a pressure contact arrangement. Other configurations are possible and the example embodiments discussed do not limit the possible arrangements.

At least one blade 24 is attached to the fin 22. The blade 24 provides a structure to penetrate into the spaces 20 between the fuel rods 14 in the fuel assembly 22. The blade 24 allows heat generated by the rods 14 of the fuel assembly 12 to be conducted along the length of the blade 24 and transferred to the fin 22. The blade 24 may be configured from thermally conductive material such as aluminum, copper or silver to adequately transfer heat to the fin 22. Alloys of thermally conductive materials may also be used. The blade 24 may be constructed such that it penetrates a full diameter 28 of the fuel assembly 12 or may be a partial diameter length. The blade 24 may be designed to penetrate deep into the interior of a fuel assembly to allow heat generated near the core of the assembly to be conducted through the blade 24 to the fin 22. In this way, the shunt 10 may provide for conduction of heat from inside a fuel assembly, thereby allowing positioning of fuel assemblies of differing decay heat values throughout a dry storage cask. A neutron absorber material may be used in the fabrication of the blade 22, or may be additionally coated or attached to the blade 22. The blade 24 may additionally be configured such that the geometry provides a taper of the cross-sectional area to allow ease of installation of the blade 24.

An attachment 30 may be formed on the shunt 10 to allow heat from the shunt 10 to be conducted out. The attachment 30 may be constructed of corrosion-resistant material to limit corrosion products within the dry storage cask. The material may also be radiation resistant to allow for long term installation in the storage cask. The material used for the attachment 30 may also be chosen to limit wear on the basket in the case of vibratory or jarring movement of the cask. The attachment 30 may be installed such that a simple contact of the attachment 30 to the basket will transfer heat conducted by the fin 22 to the basket. Other configurations are also possible including for example a welded connection, a clip or other appropriate connection.

Thermal shunts 10 may also be considered during the initial design process of the dry cask. The benefits from such a design may be numerous. If a thermal shunt 10 is used, less heat-transfer performance may be allocated to the basket of the dry cask such that the basket wall thickness can be reduced. Criticality control may be allocated to the shunts 10 rather than to absorber rods positioned inside the fuel assembly or the basket or flux traps. If provided in the original design, the shunt may totally eliminate the need for absorber rods and flux traps if a shunt 10 is provided with sufficient neutron attenuation material. Basket wall thickness may also be reduced if thermal shunts 10 with neutron attenuation are used. A smaller and lighter cask may be designed if thermal shunts 10 are installed in the fuel assembly thereby enhancing movement of the cask by cranes and handling equipment and reducing heavy load lift over plant safety sensitive areas.

The shunt 10 may be fabricated such that quality assurance features are provided ensuring consistent fabrication and material conformance to design parameters. Materials chosen to construct the shunt 10 may allow for a range of temperatures ultimately allowing placement of the dry cask in an outdoor environment. Designs of the shunt 10 may also include allowance in material strengths to eliminate brittle fracture concerns.

Referring to FIG. 2, a fuel assembly 36 is shown with a plurality of fuel rods 40. Spacer grids 38 may be positioned along the fuel assembly 36 providing lateral restraint for the rods 40. As shown, a plurality of thermal shunts 10 may be installed on the fuel assembly 36 such that differing areas of the fuel assembly 36 may be relieved of heat. The thermal shunts 10 may be installed such that they do not contact the spacer grids 38. A bridge 32 may be installed between shunts 10 to provide a linking between shunts 10 allowing the shunts 10 to act as a unified arrangement 42. Alternatively, the bridge 32 may be formed as an integral part of the shunt 10. In such a design, a single long fin 22 would support several lengths of blade 24, with each length of blade 24 sized and positioned to fit between two adjacent spacer grids.

Operationally, a thermal shunt 10 is placed between grid spacers of the spent nuclear fuel assembly 12 and inserted blade 24 first into the space 20 between the fuel rods 14. The insertion of the blade 24 into the fuel assembly 12, in the example embodiment shown in FIG. 1 allows for a complete insertion. The thermal shunt 10 is inserted until the connection 26 comes into contact with the fuel rods 14 of the fuel assembly 12. The connection 26 is then secured to a fuel rod 14 to prevent slippage of the shunt 10 during movement of the cask. As shown in the example embodiment, the process may be repeated to an extent that several shunts 10 are installed on a single fuel assembly 12. The shunts 10 may be installed by a remote control device to limit worker occupational exposure. The shunts 10 may be installed in a dry or in a wet environment such as a fuel pool.

Heat generated through radioactive decay of the spent fuel assembly 12 is imparted to the blade 24 of the thermal shunt 10 through either the cooling medium or through direct conduction between the blade 24 and the assembly 12. The heat then conducts along the blade 24 to the fin 22. The exterior placement of the fin 22 allows the heat from the center of the fuel assembly 12 to more easily pass out of the assembly to the cask. In an alternative configuration, an attachment 30 between the fin 22 and the basket allows the heat from the blade 24 to be conducted along its length to the fin 22 and eventually the basket for the spent fuel cask.

In the foregoing specification, the invention has been described with reference to specific exemplary embodiments thereof. It will, however, be evident that various modifications and changes may be made thereunto without departing from the broader spirit and scope of the invention set forth in the appended claims. The specification and drawings are accordingly to be regarded in an illustrative rather than a restrictive sense.

What is claimed is:

1. A structure for removing heat from a spent nuclear fuel assembly comprising:
a fin made from a thermally conductive material;
a connector connected to the fin, the connector configured to be connected to the spent nuclear fuel assembly; and
at least one blade connected to the fin, the at least one blade made from a thermally conductive material to be inserted in a space between the plurality of fuel rods.

2. The structure according to claim 1, wherein the thermally conductive material is aluminum.

3. The structure according to claim 1, wherein the thermally conductive material is copper.

4. The structure according to claim 1, wherein at least one of the fin, the connector and the at least one blade are made from a neutron absorbing material.

5. The structure according to claim 1, wherein at least one of the fin, the connector and the at least one blade are coated with a neutron absorbing material.

6. The structure according to claim 1, wherein a neutron absorbing material is attached to at least one of the fin, the at least one blade and the connector.

7. The structure according to claim 1, wherein the at least one blade is configured with a length equal to a diameter of a fuel assembly.

8. The structure according to claim 1, wherein the at least one blade is configured with a length less than a diameter of a fuel assembly.

9. The structure according to claim 1, wherein the connector and the at least one blade are connected to the fin through welding.

10. The structure according to claim 1, wherein the thermally conductive material is an aluminum-base alloy.

11. The structure according to claim 1, wherein the thermally conductive material is a copper-base alloy.

12. A structure for removing heat from a spent fuel assembly comprising:
a fin made from a thermally conductive material;
a connector connected to the fin the connector configured to be connected to the spent fuel assembly;
at least one blade connected to the fin and made from a thermally conductive material, the blade further configured to be inserted in a space between the plurality of fuel rods; and
an attachment connected to the fin, the attachment configured to conduct heat from the fin.

13. The structure according to claim 12, wherein the thermally conductive material is aluminum.

14. The structure according to claim 12, wherein the thermally conductive material is copper.

15. The structure according to claim 12, wherein at least one of the fin, the connector and the at least one blade are made from a neutron absorbing material.

16. The structure according to claim 12, wherein at least one of the fin, the connector and the at least one blade are coated with a neutron absorbing material.

17. The structure according to claim 12, wherein a neutron absorbing material is attached to at least one of the fin, the at least one blade and the connector.

18. The structure according to claim 12, wherein the blade is configured with a length equal to the diameter of the fuel assembly.

19. The structure according to claim 12, wherein the at least one blade is configured with a length less than the diameter of the fuel assembly.

20. The structure according to claim 12, wherein the connector and the at least one blade are connected to the fin through welding.

21. The structure according to claim 12, wherein the thermally conductive material is an aluminum-base alloy.

22. The structure according to claim 12, wherein the thermally conductive material is a copper-base alloy.

23. A method for cooling a spent nuclear fuel assembly comprising:
attaching a thermal shunt to the fuel assembly;
receiving heat from the fuel assembly into the thermal shunt;
conducting the heat through the thermal shunt; and
dissipating the heat.

24. The method for cooling a spent nuclear fuel assembly according to claim 23, further comprising:
attaching the thermal shunt to a dry storage cask immediately after attaching the thermal shunt to the fuel assembly.
